(19) United States
(12) Patent Application Publication
(10) Pub. No.: US 2016/0078807 A1
(43) Pub. Date: Mar. 17, 2016

(54) DISPLAY PANEL, ORGANIC LIGHT EMITTING DIODE DISPLAY DEVICE AND DISPLAY DEVICE

(71) Applicant: Boe Technology Group Co., Ltd., Beijing (CN)

(72) Inventors: Liang Sun, Beijing (CN); Tuo Sun, Beijing (CN); Xiaodan Jin, Beijing (CN); Lintao Zhang, Beijing (CN)

(21) Appl. No.: 14/555,952

(22) Filed: Nov. 28, 2014

(30) Foreign Application Priority Data
Sep. 11, 2014 (CN) 201410459909.3

(51) Int. Cl. G09G 3/32

(52) U.S. Cl. CPC G09G 3/3233; G09G 2300/0809; G09G 2320/043; G09G 2300/0465; G09G 2300/0876; G09G 2320/029

(57) ABSTRACT

This disclosure relates to a display panel, an organic light emitting diode display and a display device comprising the display panel. The display panel according to one aspect of this disclosure comprises a plurality of pixels each comprising a first sub-pixel, a second sub-pixel and a third sub-pixel, wherein the first sub-pixel and the second sub-pixel are arranged in the row direction, the first sub-pixel in each pixel is adjacent to the first sub-pixel in a pixel adjacent in the row direction, the second sub-pixel in each pixel is adjacent to the second sub-pixel in another pixel adjacent in the row direction, the geometrical center of the third sub-pixel in each pixel is distributed uniformly on the display panel. By means of the display panel of this disclosure, the area of the light emitting area in the pixel can be increased, the aperture ratio can be improved, so as to realize high display quality.

### RELATED APPLICATIONS

The present application claims the benefit of Chinese application No. 201410459909.3 filed with the SIPO on Sep. 11, 2014, the entire disclosure of which is incorporated herein by reference.

### FIELD OF THE DISCLOSURE

This disclosure relates to a display panel, an organic light emitting diode display and a display device comprising the display panel.

### BACKGROUND OF THE DISCLOSURE

In the prior art of fabricating the top emission active matrix organic light emitting diode (AMOLED) panel, when the high precision metal mask plate (FMM) is used to evaporate pixels arranged side by side, it is inevitably limited by the aperture size of the high precision metal mask plate and the precision of the evaporation process, such that it is difficult to realize high resolution. Meanwhile, when the resolution is relatively high, it is difficult to ensure the aperture ratio (the aperture ratio in the present field generally refers to the proportion between the area of the light emitting area of the pixel area and the area of the repeatable pixel unit of the display area. The higher the aperture ratio is, the lower the brightness is required by each pixel light emitting area for achieving the same display brightness, and the lower the current density of the light emitting area brightness is) of the sub-pixel, thereby the properties, such as the life time, brightness etc., of the product might be influenced. Generally, the high precision metal mask plate has the limitation of the minimum aperture, in the evaporation process, the sub-pixels of different colors have the limitation of the distance between the apertures.

Therefore, how to realize high resolution, and at meantime, improve the aperture ratio of the sub-pixel, obtain a better brightness level, and prolong the life time of the produce is always a problem to be solved in the art.

### SUMMARY OF THE DISCLOSURE

In view of this, this disclosure provides a display panel, an organic light emitting diode display and a display device comprising the display panel, which can solve or at least mitigate at least part of the defects existing in the prior art.

According to a first aspect of this disclosure, a display panel is provided, which may comprise a plurality of pixel units each comprising a first sub-pixel, a second sub-pixel and a third sub-pixel, wherein the first sub-pixel and the second sub-pixel are arranged in the row direction, and except for the first and the last pixel unit of each row, the first sub-pixel in each pixel unit is adjacent to the first sub-pixel in a pixel unit adjacent in the row direction, the second sub-pixel in each pixel unit is adjacent to the second sub-pixel in another pixel unit adjacent in the row direction, the third sub-pixel in each pixel unit is located in a row adjacent to the row where the first sub-pixel and the second sub-pixel in the pixel unit are located, and is adjacent to the first sub-pixel and the second sub-pixel in the pixel unit, the geometrical center of the third sub-pixel in each pixel unit is distributed uniformly on the display panel.

By means of the display panel according to one embodiment of this disclosure, the resolution is increased (i.e., the density of the sub-pixel is increased). Meanwhile, by enabling the first sub-pixel, the second sub-pixel to adjoin with each other, e.g., adjoining a B sub-pixel with an adjacent B sub-pixel, adjoining a R sub-pixel with an adjacent R sub-pixel, the area of not emitting light between the sub-pixels is reduced, and the aperture ratio is increased. In addition, the geometrical center of the G sub-pixels with a relatively high human recognition are distributed uniformly in the row direction and the column direction of the display panel, which ensures display quality in the row direction and the column direction.

In an embodiment of this disclosure, the first and the last pixel unit of each row are adjacent to the first sub-pixel or the second sub-pixel in a pixel unit adjacent to them in the row direction.

Alternatively, in each pixel unit and a pixel unit adjacent to it in the row direction, two adjacent first sub-pixels constitute a first sub-pixel group, two adjacent second sub-pixels constitute a second sub-pixel group, the geometrical centers of a first sub-pixel group and a second sub-pixel group adjacent in the row direction and the geometrical centers of another first sub-pixel group and another second sub-pixel group adjacent in the column direction to the first sub-pixel group and the second sub-pixel group adjacent in the row direction form a rectangle, the geometrical center of the third sub-pixel is on the diagonal intersection of the rectangle.

Alternatively, the geometrical centers of a first sub-pixel group and a second sub-pixel group adjacent in the row direction and the geometrical centers of another first sub-pixel group and another second sub-pixel group adjacent in the column direction to the first sub-pixel group and the second sub-pixel group adjacent in the row direction form a square, the geometrical center of the third sub-pixel is on the diagonal intersection of the square.

In another embodiment of this disclosure, the first sub-pixel and the second sub-pixel in each pixel unit are both polygons arranged in the row direction.

In a further embodiment of this disclosure, the first sub-pixel and the second sub-pixel in each pixel unit have the same shape.

Preferably, the first sub-pixel and the second sub-pixel in each pixel unit are both trapezoids in the row direction. Alternatively, the upper base of the trapezoidal first sub-pixel in each pixel unit is adjacent to the upper base of the trapezoidal second sub-pixel.

In a variant embodiment of this disclosure, the first sub-pixel and the second sub-pixel in each pixel unit are both rectangles arranged in the row direction.

In yet another embodiment of this disclosure, the geometrical center of the first sub-pixel group and the geometrical center of the second sub-pixel group are arranged alternately in the row direction and the column direction.

In respective embodiments of this disclosure, the first sub-pixel may be a R sub-pixel, the second sub-pixel may be a B sub-pixel, the third sub-pixel may be a G sub-pixel, or the first sub-pixel is a B sub-pixel, the second sub-pixel is a R sub-pixel, the third sub-pixel is a G sub-pixel, or the first sub-pixel is a G sub-pixel, the second sub-pixel is a B sub-pixel, the third sub-pixel is a R sub-pixel, or the first sub-pixel is a G sub-pixel, the second sub-pixel is a R sub-pixel, the third sub-pixel is a B sub-pixel, or the first sub-pixel is a R sub-pixel, the second sub-pixel is a G sub-pixel, the third sub-pixel is a B sub-pixel, or the first sub-pixel is a B sub-pixel, the second sub-pixel is a G sub-pixel, the third sub-pixel is a R sub-pixel.

The G sub-pixel in each pixel unit is a quadrangle, and is arranged towards the same direction on the display panel. Alternatively, the G sub-pixel in each pixel unit is a quadrangle, and the G sub-pixel on the display panel is arranged alternately towards a different direction. Alternatively, the adjacent G sub-pixels are arranged in mirror symmetry.

According to a second aspect of this disclosure, an organic light emitting diode display is provided, which may comprise a display panel mentioned above.

According to a third aspect of this disclosure, a display device is provided, comprising a display panel mentioned above.

### BRIEF DESCRIPTION OF DRAWINGS

By explaining in detail the embodiments in conjunction with the drawings, the above and other features of this disclosure will be more obvious, wherein:

FIG. 1 schematically shows a first arrangement of R sub-pixels, G sub-pixels, and B sub-pixels in the prior art.

FIG. 2 schematically shows a second arrangement of R sub-pixels, G sub-pixels, and B sub-pixels in the prior art.

FIG. 3 schematically shows a third arrangement of R sub-pixels, G sub-pixels, and B sub-pixels in the prior art.

FIG. 4 schematically shows an arrangement of R sub-pixels, G sub-pixels, and B sub-pixels according to an embodiment of this disclosure.

FIG. 5 schematically shows the relationship among R sub-pixels, G sub-pixels, and B sub-pixels in respective pixels according to another embodiment of this disclosure.

### DETAILED DESCRIPTION OF THE DISCLOSURE

It should be indicated firstly that the terms such as “up”, “low”, “left”, “right”, “row direction”, “column direction” etc., regarding positions and directions mentioned in this disclosure are directions viewed from the paper face of the drawings. Therefore, the terms such as “up”, “low”, “left”, “right”, “row direction”, “column direction” etc., regarding positions and directions in this disclosure only represent relative position relationships as shown in the drawings, this is only given for the purpose of explanations, not intended to limit the scope of this disclosure. For example, in some cases, the embodiments concerning the “row direction” can be carried out in the case of the “column direction” etc., and vice versa. It also belongs to the category of this patent right to perform rotation of 90 degrees or mirror image to the solution of this patent.

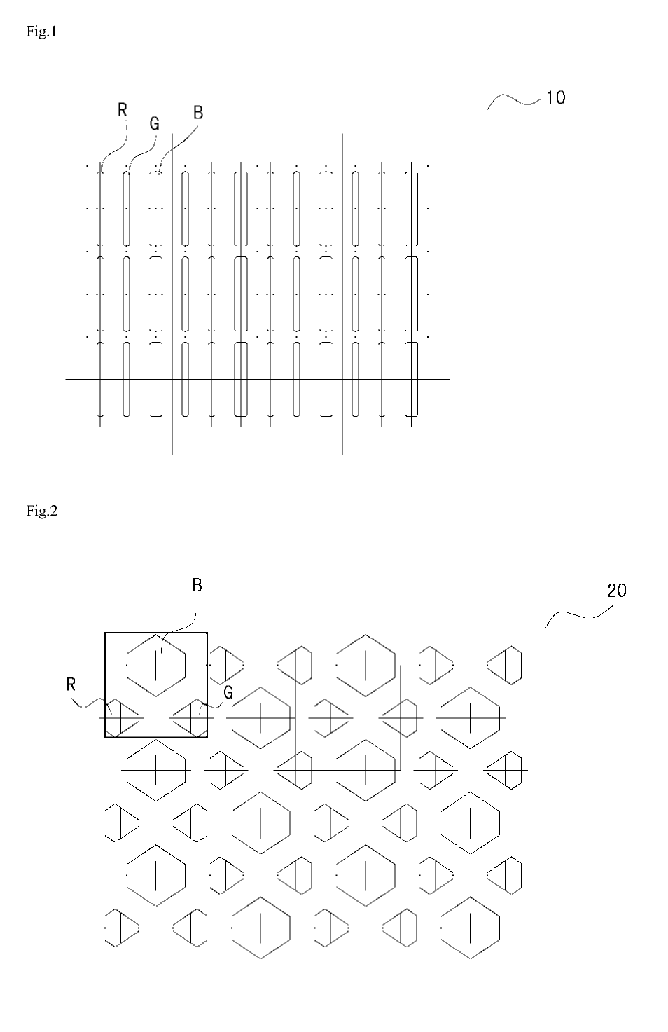

Next, this disclosure will be described in detail with reference to FIGS. 1-5.

FIG. 1 schematically shows a first arrangement 10 of R sub-pixels, G sub-pixels, and B sub-pixels in the prior art. FIG. 1 schematically shows an arrangement of R sub-pixels, G sub-pixels, and B sub-pixels in a pixel of the prior art, wherein the R sub-pixels, the G sub-pixels, and the B sub-pixels are distributed in the row direction. Due to the limitation of the minimum aperture of FMM and the distance limitation of different color apertures in the evaporation process, it is relatively difficult to compress the size in the row direction, meanwhile, it results in decrease of the aperture ratio of the R sub-pixels, the G sub-pixels, and the B sub-pixels. Generally, the arrangement of FIG. 1 can only realize a resolution about 200 ppi (pixel per inch), and an aperture ratio of 20˜30%.

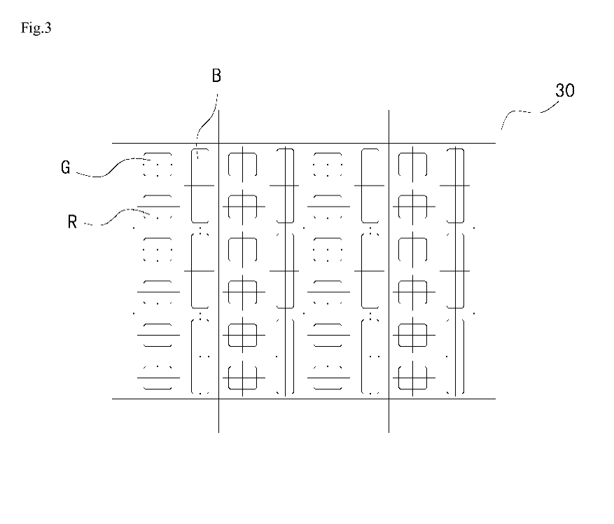

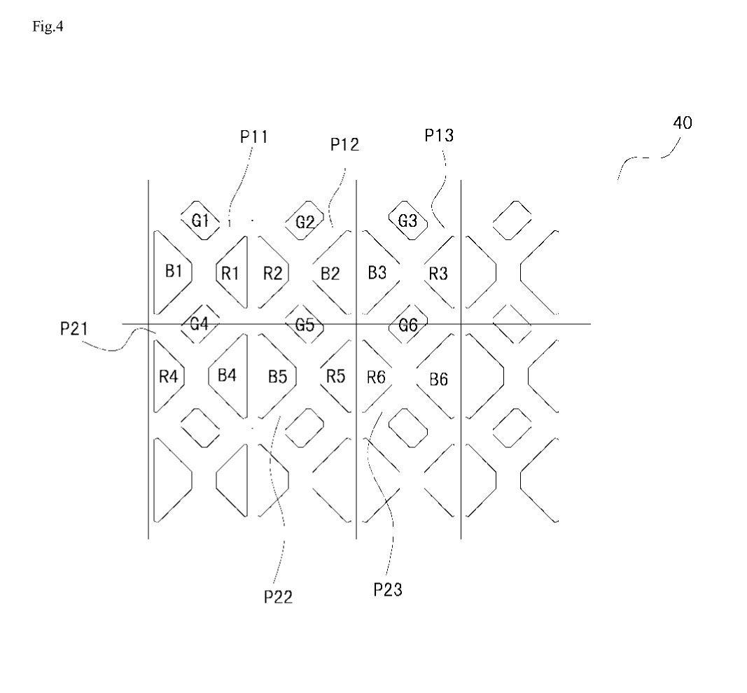

FIG. 2 schematically shows a second arrangement 20 of R sub-pixels, G sub-pixels, and B sub-pixels in the prior art, while FIG. 3 schematically shows a third arrangement 30 of R sub-pixels, G sub-pixels, and B sub-pixels in the prior art. It is schematically shown in FIG. 2 and FIG. 3 that R sub-pixels, G sub-pixels, and B sub-pixels in a pixel are distributed uniformly in the row direction and the column direction. Although relative to the arrangement of FIG. 1, FIG. 2 and FIG. 3 increase some aperture ratios by transferring the size limitation in the row direction to the column direction, and compress the size of the sub-pixel to some extent, however, due to the limitation of the minimum aperture of FMM and the distance limitation of different color apertures in the evaporation process, the arrangement of FIG. 3 can only realize a resolution less than 300 ppi and an aperture ratio of 30˜35% generally.

However, how to increase the resolution further, reduce the area of not emitting light between the sub-pixels, and increase the aperture ratio are still pursued diligently by the skilled person in the art for achieving higher display quality.

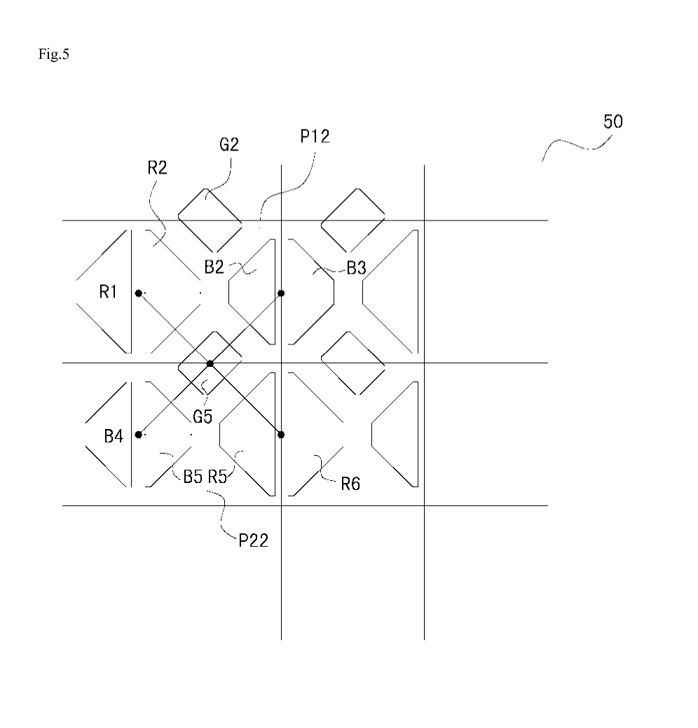

Based on such an assumption exactly, this disclosure proposes a display panel 40, wherein the R sub-pixel in a pixel, e.g. the R2 sub-pixel shown in in pixel P12 of FIG. 4, is adjacent to a R sub-pixel in a pixel adjacent to the pixel in the row direction, e.g. the R1 sub-pixel shown in pixel P11 of FIG. 4. The B sub-pixel in the pixel, e.g. the B2 sub-pixel shown in pixel P13 of FIG. 4, is adjacent to a B sub-pixel in another pixel adjacent to the pixel in the row direction, e.g., the B3 sub-pixel shown in pixel P13 of FIG. 4. It can be seen in FIG. 4 that the R2 sub-pixel in a pixel is adjacent to the R1 sub-pixel in an adjacent pixel in the row direction, and the B2 sub-pixel in the pixel is adjacent to the B3 sub-pixel in another adjacent pixel in the row direction. The geometrical center of the G sub-pixel in each pixel is distributed uniformly on the display panel 40. In the display panel 40 as shown in FIG. 4, it can be seen that G1, G2, G3 . . . are distributed uniformly on the whole display panel. As for how the geometrical centers of the G sub-pixels are distributed, it will be described in detail later. Since the G sub-pixels with relatively high human recognition are distributed uniformly in the transverse and column directions of the display panel, the display quality in the transverse and column directions is ensured. In respective pixels, the G sub-pixels may be in an approximate rectangular shape with four angles having smooth chamfers, for example, G1, G2, G3 . . . as shown in FIG. 4 are exactly in such a shape. In respective embodiments of this disclosure, the G sub-pixels may be either in a center symmetric circular shape or in a non center symmetric ellipse shape etc. However, no matter the G sub-pixels are center symmetric or non center symmetric, the G sub-pixels have their own geometrical centers, this is not difficult for the skilled person in the art to understand.

The display panel 40 according to an embodiment of this disclosure may comprise a plurality of pixel units each comprising a first sub-pixel, a second sub-pixel and a third sub-pixel, wherein the first sub-pixel and the second sub-pixel are arranged in the row direction, and except for the first and the last pixel unit of each row , the first sub-pixel in each pixel unit is adjacent to the first sub-pixel in a pixel unit adjacent in the row direction, the second sub-pixel in each pixel unit is adjacent to the second sub-pixel in another pixel unit adjacent in the row direction, the third sub-pixel in each pixel unit is located in a row adjacent to the row where the first sub-pixel and the second sub-pixel in the pixel unit are located, and is adjacent to the first sub-pixel and the second sub-pixel in the pixel unit, the geometrical center of the third sub-pixel in each pixel unit is distributed uniformly on the display panel. Preferably, the first and the last pixel unit of each row are adjacent to the first sub-pixel or the second sub-pixel in a pixel unit adjacent to them in the row direction.

In another embodiment of this disclosure, in each pixel unit and a pixel unit adjacent to it in the row direction, two adjacent first sub-pixels constitute a first sub-pixel group, two adjacent second sub-pixels constitute a second sub-pixel group, the geometrical centers of a first sub-pixel group and a second sub-pixel group adjacent in the row direction and the geometrical centers of another first sub-pixel group and another second sub-pixel group adjacent in the column direction to the first sub-pixel group and the second sub-pixel group adjacent in the row direction form a rectangle, the geometrical center of the third sub-pixel is on the diagonal intersection of the rectangle.

Alternatively, the geometrical centers of a first sub-pixel group and a second sub-pixel group adjacent in the row direction and the geometrical centers of another first sub-pixel group and another second sub-pixel group adjacent in the column direction to the first sub-pixel group and the second sub-pixel group adjacent in the row direction form a square, the geometrical center of the third sub-pixel is on the diagonal intersection of the square.

FIG. 4 schematically shows pixel P11, pixel P12, pixel P13 . . . in the first row and pixel P21, pixel P22, pixel P23 . . . in the second row, each pixel has corresponding sub-pixels R, G, B. For example, there are sub-pixels R1, G1, B1 in pixel P11, sub-pixels R2, G2, B2 in pixel P12, sub-pixels R3, G3, B3 in pixel P13 . . . . The pixel P11, pixel P12, Pixel P13 . . . represented by the blocks as shown in FIG. 4 are arranged side by side in the first row along the row direction, the pixel P21, pixel P22, Pixel P23 . . . are arranged side by side in the second row along the row direction. Since the row direction and the column direction are relative concepts, if the pixel P11, pixel P12, pixel P13 . . . and the pixel P21, pixel P22, pixel P23 . . . are arranged in the column direction, the technical effect of this disclosure can be also achieved. Although such a case is not shown in the drawings, it is not difficult for the skilled person in the art to understand.

By means of such an arrangement of sub-pixels, the resolution (which may be greater than 300 ppi) is improved, and the area of not emitting light between the sub-pixels is reduced, the aperture ratio reaches about 42%, moreover, the preparation process of the display panel can be simplified.

FIG. 5 schematically shows the arrangement of sub-pixels R, G, B according to an embodiment of this disclosure, FIG. 5 is for describing the arrangement of the sub-pixels R, G, B in FIG. 4 more clearly. FIG. 5 amplifies an entire pixel P12, an entire pixel P22 and part or full of pixels P11, P13, P21, P23 as shown in Fig, 4. The geometrical centers of the G sub-pixels G1, G2, G3 . . . in each pixel being distributed uniformly on the display panel 50 may comprise the following cases: the R sub-pixel R2 in pixel P12 and the R sub-pixel R1 in a pixel P11 adjacent to said pixel in the row direction constitute a R sub-pixel group R1, R2, the B sub-pixel B2 in the pixel P12 and the B sub-pixel B3 in another pixel P13 adjacent to the pixel P12 in the row direction constitute a B sub-pixel group B2, B3, the geometrical center of the R sub-pixel group R1, R2, the geometrical center of the B sub-pixel group B2, B3, the geometrical center of another R sub-pixel group R5, R6 adjacent to the B sub-pixel group B2, B3 in the column direction, and the geometrical center of another B sub-pixel group B4, B5 adjacent to the R sub-pixel group R1, R2 in the column direction constitute a rectangle, the geometrical center of the G sub-pixel G5 is on the diagonal intersection of the rectangle.

It needs to point out that as for the R sub-pixels and the B sub-pixels, the term “geometrical center” mentioned in this disclosure respectively refers to the center of the geometrical shape enclosed by two adjacent R sub-pixels that constitute a R sub-pixel group or two adjacent B sub-pixels that constitute a B sub-pixel group. As for the G sub-pixels, the term “geometrical center” refers to the center of the geometrical shape of a single G sub-pixel. For example, as shown in FIG. 5, the geometrical center of the R sub-pixel group R1, R2 refers to the center of the geometrical shape enclosed by two adjacent R sub-pixels R1, R2. Similarly, the geometrical center of the B sub-pixel group B2, B3 refers to the center of the geometrical shape enclosed by two adjacent B sub-pixels B2, B3, and so on. The five black points in FIG. 5 show the geometrical center of the R sub-pixel group R1, R2, the geometrical center of the B sub-pixel group B2, B3, the geometrical center of the R sub-pixel group R5, R6, the geometrical center of the B sub-pixel group B4, B5, and the geometrical center of the sub-pixel of G5.

Alternatively, the geometrical center of the R sub-pixel group R1, R2, the geometrical center of the B sub-pixel group B2, B3, the geometrical center of another R sub-pixel group R5, R6 adjacent to the B sub-pixel group B2, B3 in the column direction, and the geometrical center of another B sub-pixel group B4, B5 adjacent to the R sub-pixel group R1, R2 in the column direction constitute a square, the geometrical center of the G sub-pixel G5 is on the diagonal intersection of the square.

By means of such an arrangement of sub-pixels, the resolution (which may be greater than 300 ppi) is also increased, and the area of not emitting light between the sub-pixels is reduced, and the aperture ratio reaches about 42%.

In an embodiment of this disclosure, the display panel 40 comprises geometrical centers of a plurality of first sub-pixel groups and geometrical centers of a plurality of second sub-pixel groups, wherein the geometrical center of each first sub-pixel group is adjacent to the geometrical centers of the second sub-pixel groups in the row direction and the column direction, the geometrical center of each second sub-pixel group is adjacent to the geometrical centers of the first sub-pixel groups in the row direction and the column direction. For example, the B sub-pixel and the R sub-pixel in each pixel may be both polygons arranged in the row direction, the geometrical center of the B sub-pixel group B2, B3, the geometrical center of the R sub-pixel group R1, R2, the geometrical center of another R sub-pixel group R5, R6 adjacent to the B sub-pixel group B2, B3 in the column direction are adjacent in the column direction and the row direction. Alternatively, the first sub-pixel and the second sub-pixel in each pixel unit may have the same shape. The R sub-pixel group is constituted by two independently driven R sub-pixels, the B sub-pixel group is constituted by two independently driven B sub-pixels. Alternatively, the first sub-pixel and the second sub-pixel in each pixel unit are both trapezoids arranged in the row direction. For example, the upper base of the trapezoidal first sub-pixel in each pixel unit is adjacent to the upper base of the trapezoidal second sub-pixel. Or, the first sub-pixel and the second sub-pixel in each pixel unit are both rectangles arranged in the row direction.

Alternatively, the B sub-pixel and the R sub-pixel in each pixel in each pixel can be both trapezoids arranged in the column direction. For example, the B1 sub-pixel, R1 sub-pixel, B2 sub-pixel, R2 sub-pixel, B3 sub-pixel, R3 sub-pixel . . . in FIG. 4 are all arranged in the column direction or vertically arranged. The upper base of the trapezoid shape of the B sub-pixel is adjacent to the upper base of the trapezoid shape of the R sub-pixel in the row direction, for example, the B1 sub-pixel, the R1 sub-pixel shown in pixel P11 of FIG. 4 are exactly such cases. The lower base of the trapezoid shape of the R sub-pixel is adjacent to the lower base of the trapezoid shape of the R sub-pixel in a pixel adjacent to this pixel in the row direction, for example, the lower base of the trapezoid shape of the R2 sub-pixel shown in the pixel P12 of FIG. 4 is adjacent to the lower base of the trapezoid shape of the R1 sub-pixel in a pixel e.g. pixel P11 adjacent in the row direction. The lower base of the trapezoid shape of the B sub-pixel in this pixel is adjacent to the lower base of the trapezoid shape of the B sub-pixel in another pixel adjacent to this pixel in the row direction, for example, the lower base of the trapezoid shape of the B2 sub-pixel shown in pixel P12 of FIG. 4 is adjacent to the lower base of the trapezoid shape of the B3 sub-pixel in a pixel e.g. pixel P13 adjacent in the row direction. Similarly, since the row direction and the column direction are relative concepts, in a variant embodiment of this disclosure, the B sub-pixel and the R sub-pixel in each pixel can be both in a trapezoid shape arranged in the row direction, here the upper base of the trapezoid shape of the B sub-pixel is adjacent to the upper base of the trapezoid shape of the R sub-pixel in the column direction, the lower base of the trapezoid shape of the R sub-pixel is adjacent to the lower base of the trapezoid shape of the R sub-pixel in a pixel adjacent to this pixel in the column direction, the lower base of the trapezoid shape of the B sub-pixel in this pixel is adjacent to the lower base of the trapezoid shape of the B sub-pixel in another pixel adjacent to this pixel in the column direction. Although such cases are not shown in the drawings, it is not difficult for the skilled person in the art to understand. By means of such an arrangement of the sub-pixels, the resolution (which may be greater than 300 ppi) is also improved. Moreover, the area of not emitting light between the sub-pixels is reduced, and the aperture ratio reaches about 42%.

It should be pointed out that the upper base of the trapezoid shape refers to the relatively short base row in the trapezoid, the lower base refers to the relatively long base row in the trapezoid. The trapezoid shapes of the above R, B sub-pixels are only schematic, the shapes of the R, B sub-pixels in respective embodiments of this disclosure should not be limited to the trapezoid shape, instead, they may be in polygon shapes such as rectangle etc. In addition, in the above respective embodiments of this disclosure, although the G sub-pixels in respective pixels may be in an approximate rectangular shape with four angles having smooth chamfers, the G sub-pixels in this disclosure should not be limited to the approximate rectangular shape, which can also be in a rectangular shape without chamfer angles, or a square shape with four angles having chamfers or having no chamfers, or a triangle shape etc.

The gist of this disclosure does not lie in the shapes of the R sub-pixel, the G sub-pixel, and the B sub-pixel, but the position relationship between the R sub-pixel and the B sub-pixel. That is, the B sub-pixel in the same pixel is adjacent to the B sub-pixel in an adjacent pixel, the R sub-pixel in the same pixel is adjacent to the R sub-pixel in another adjacent pixel. The adjacent pixel and another adjacent pixel mentioned in respective embodiments of this disclosure may be either adjacent pixels in the row direction or adjacent pixels in the column direction, combined with the above depiction of the description, it is not difficult for the skilled person in the art to understand.

In respective embodiments of this disclosure, the geometrical center of the first sub-pixel group and the geometrical center of the second sub-pixel group are arranged alternately in the row direction and the column direction. For example, the geometrical center of the B sub-pixel group and the geometrical center of the R sub-pixel group are arranged alternately in the column direction and the row direction. For example, the four black points (the block point representing the geometrical center of G5 is not considered) shown in FIG. 5 exactly show that the geometrical center of the B sub-pixel group and the geometrical center of the R sub-pixel group are adjacent in the column direction and the row direction. In respective embodiments of this disclosure, the R sub-pixel group is constituted by two independently driven R sub-pixels, the B sub-pixel group is constituted by two independently driven B sub-pixels.

In respective embodiments of this disclosure, wherein the first sub-pixel may be a R sub-pixel, the second sub-pixel may be a B sub-pixel, the third sub-pixel may be a G sub-pixel, or the first sub-pixel is a B sub-pixel, the second sub-pixel is a R sub-pixel, the third sub-pixel is a G sub-pixel, or the first sub-pixel is a G sub-pixel, the second sub-pixel is a B sub-pixel, the third sub-pixel is a R sub-pixel, or the first sub-pixel is a G sub-pixel, the second sub-pixel is a R sub-pixel, the third sub-pixel is a B sub-pixel, or the first sub-pixel is a R sub-pixel, the second sub-pixel is a G sub-pixel, the third sub-pixel is a B sub-pixel, or the first sub-pixel is a B sub-pixel, the second sub-pixel is a G sub-pixel, the third sub-pixel is a R sub-pixel.

In an embodiment of this disclosure, in each pixel unit and a pixel unit adjacent to it in the row direction, two adjacent first sub-pixels constitute a first sub-pixel group, two adjacent second sub-pixels constitute a second sub-pixel group, the geometrical centers of a first sub-pixel group and a second sub-pixel group adjacent in the row direction and the geometrical centers of another first sub-pixel group and another second sub-pixel group adjacent in the column direction to the first sub-pixel group and the second sub-pixel group adjacent in the row direction form a rectangle, the geometrical center of the third sub-pixel is on the diagonal intersection of the rectangle. Alternatively, wherein the geometrical centers of a first sub-pixel group and a second sub-pixel group adjacent in the row direction and the geometrical centers of another first sub-pixel group and another second sub-pixel group adjacent in the column direction to the first sub-pixel group and the second sub-pixel group adjacent in the row direction form a square, the geometrical center of the third sub-pixel is on the diagonal intersection of the square.

In an embodiment of this disclosure, the geometrical center of the G sub-pixel in each pixel being distributed uniformly on the display panel 40 comprises that the G sub-pixel in each pixel is arranged towards the same direction on the display panel 40. Although it is not shown in the drawings, it is not difficult for the skilled person in the art to understand.

In another embodiment of this disclosure, the geometrical center of the G sub-pixel in each pixel being distributed uniformly on the display panel 40 comprises that the G sub-pixel in each pixel unit is a quadrangle, and is arranged towards the same direction on the display panel. Or the G sub-pixel in each pixel unit is a quadrangle, and the G sub-pixel on the display panel is arranged alternately towards different directions. FIG. 4 shows that the G3 sub-pixel is arranged towards the upper left direction tiltedly, the G1 sub-pixel is arranged towards the upper right direction tiltedly, the G2 sub-pixel is arranged towards the upper left direction tiltedly again . . . , and thus arranged orderly. It needs to point out that any arrangement manner of the G sub-pixels falls within the protection scope of this disclosure as long as the G sub-pixel can be distributed uniformly on the display panel 40.

According to a second aspect of this disclosure, an organic light emitting diode display is provided, which may comprise a display panel mentioned above.

According to a third aspect of this disclosure, a display device is provided, which may comprise a display panel mentioned above.

Although this disclosure has been described with reference to the currently considered embodiments, it should be understood that this disclosure is not limited to the disclosed embodiments. On the contrary, this disclosure aims to cover various modifications and equivalent arrangements included within the spirit and scope of the appended claims. The scopes of the following claims are in row with the most extensive interpretation so as to cover each of such modifications as well as equivalent structures and functions.

1. A display panel comprising a plurality of pixel units each comprising a first sub-pixel, a second sub-pixel and a third sub-pixel, wherein the first sub-pixel and the second sub-pixel are arranged in the row direction, and except for the first and the last pixel unit of each row, the first sub-pixel in each pixel unit is adjacent to the first sub-pixel in a pixel unit adjacent in the row direction, the second sub-pixel in each pixel unit is adjacent to the second sub-pixel in another pixel unit adjacent in the row direction, the third sub-pixel in each pixel unit is located in a row adjacent to the row where the first sub-pixel and the second sub-pixel in the pixel unit are located, and is adjacent to the first sub-pixel and the second sub-pixel in the pixel unit, the geometrical center of the third sub-pixel in each pixel unit is distributed uniformly on the display panel.

2. The display panel according to claim 1, wherein the first and the last pixel unit of each row are adjacent to the first sub-pixel or the second sub-pixel in a pixel unit adjacent to them in the row direction.

3. The display panel according to claim 1, wherein
in each pixel unit and a pixel unit adjacent to it in the row direction, two adjacent first sub-pixels constitute a first sub-pixel group, two adjacent second sub-pixels constitute a second sub-pixel group, the geometrical centers of a first sub-pixel group and a second sub-pixel group adjacent in the row direction and the geometrical centers of another first sub-pixel group and another second sub-pixel group adjacent in the column direction to the first sub-pixel group and the second sub-pixel group adjacent in the row direction form a rectangle, the geometrical center of the third sub-pixel is on the diagonal intersection of the rectangle.

4. The display panel according to claim 3, wherein the geometrical centers of a first sub-pixel group and a second sub-pixel group adjacent in the row direction and the geometrical centers of another first sub-pixel group and another second sub-pixel group adjacent in the column direction to the first sub-pixel group and the second sub-pixel group adjacent in the row direction form a square, the geometrical center of the third sub-pixel is on the diagonal intersection of the square.

5. The display panel according to claim 1, wherein the first sub-pixel and the second sub-pixel in each pixel unit are both polygons arranged in the row direction.

6. The display panel according to claim 5, wherein the first sub-pixel and the second sub-pixel in each pixel unit have the same shape.

7. The display panel according to claim 5, wherein the first sub-pixel and the second sub-pixel in each pixel unit are both trapezoids in the row direction.

8. The display panel according to claim 7, wherein the upper base of the trapezoidal first sub-pixel in each pixel unit is adjacent to the upper base of the trapezoidal second sub-pixel.

9. The display panel according to claim 5, wherein the first sub-pixel and the second sub-pixel in each pixel unit are both rectangles arranged in the row direction.

10. The display panel according to claim 3, wherein the geometrical center of the first sub-pixel group and the geometrical center of the second sub-pixel group are arranged alternately in the row direction and the column direction.

11. The display panel according to claim 1, wherein the first sub-pixel is a R sub-pixel, the second sub-pixel is a B sub-pixel, the third sub-pixel is a G sub-pixel, or the first sub-pixel is a B sub-pixel, the second sub-pixel is a R sub-pixel, the third sub-pixel is a G sub-pixel, or the first sub-pixel is a G sub-pixel, the second sub-pixel is a B sub-pixel, the third sub-pixel is a R sub-pixel, or the first sub-pixel is a G sub-pixel, the second sub-pixel is a R sub-pixel, the third sub-pixel is a B sub-pixel, or the first sub-pixel is a R sub-pixel, the second sub-pixel is a G sub-pixel, the third sub-pixel is a B sub-pixel, or the first sub-pixel is a B sub-pixel, the second sub-pixel is a G sub-pixel, the third sub-pixel is a R sub-pixel.

12. The display panel according to claim 2, wherein the first sub-pixel is a R sub-pixel, the second sub-pixel is a B sub-pixel, the third sub-pixel is a G sub-pixel, or the first sub-pixel is a B sub-pixel, the second sub-pixel is a R sub-pixel, the third sub-pixel is a G sub-pixel, or the first sub-pixel is a G sub-pixel, the second sub-pixel is a B sub-pixel, the third sub-pixel is a R sub-pixel, or the first sub-pixel is a G sub-pixel, the second sub-pixel is a R sub-pixel, the third sub-pixel is a B sub-pixel, or the first sub-pixel is a R sub-pixel, the second sub-pixel is a G sub-pixel, the third sub-pixel is a B sub-pixel, or the first sub-pixel is a B sub-pixel, the second sub-pixel is a G sub-pixel, the third sub-pixel is a R sub-pixel.

13. The display panel according to claim 3, wherein the first sub-pixel is a R sub-pixel, the second sub-pixel is a B sub-pixel, the third sub-pixel is a G sub-pixel, or the first sub-pixel is a B sub-pixel, the second sub-pixel is a R sub-pixel, the third sub-pixel is a G sub-pixel, or the first sub-pixel is a G sub-pixel, the second sub-pixel is a B sub-pixel, the third sub-pixel is a R sub-pixel, or the first sub-pixel is a G sub-pixel, the second sub-pixel is a R sub-pixel, the third sub-pixel is a B sub-pixel, or the first sub-pixel is a R sub-pixel, the second sub-pixel is a G sub-pixel, the third sub-pixel is a B sub-pixel, or the first sub-pixel is a B sub-pixel, the second sub-pixel is a G sub-pixel, the third sub-pixel is a R sub-pixel.

14. The display panel according to claim 4, wherein the first sub-pixel is a R sub-pixel, the second sub-pixel is a B sub-pixel, the third sub-pixel is a G sub-pixel, or the first sub-pixel is a B sub-pixel, the second sub-pixel is a R sub-pixel, the third sub-pixel is a G sub-pixel, or the first sub-pixel is a G sub-pixel, the second sub-pixel is a B sub-pixel, the third sub-pixel is a R sub-pixel, or the first sub-pixel is a G sub-pixel, the second sub-pixel is a R sub-pixel, the third sub-pixel is a B sub-pixel, or the first sub-pixel is a R sub-pixel, the second sub-pixel is a G sub-pixel, the third sub-pixel is a B sub-pixel, or the first sub-pixel is a B sub-pixel, the second sub-pixel is a G sub-pixel, the third sub-pixel is a R sub-pixel.

15. The display panel according to claim 5, wherein the first sub-pixel is a R sub-pixel, the second sub-pixel is a B sub-pixel, the third sub-pixel is a G sub-pixel, or the first sub-pixel is a B sub-pixel, the second sub-pixel is a R sub-pixel, the third sub-pixel is a G sub-pixel, or the first sub-pixel is a G sub-pixel, the second sub-pixel is a B sub-pixel, the third sub-pixel is a R sub-pixel, or the first sub-pixel is a G sub-pixel, the second sub-pixel is a R sub-pixel, the third sub-pixel is a B sub-pixel, or the first sub-pixel is a R sub-pixel, the second sub-pixel is a G sub-pixel, the third sub-pixel is a B sub-pixel, or the first sub-pixel is a B sub-pixel, the second sub-pixel is a G sub-pixel, the third sub-pixel is a R sub-pixel.

16. The display panel according to claim 6, wherein the first sub-pixel is a R sub-pixel, the second sub-pixel is a B sub-pixel, the third sub-pixel is a G sub-pixel, or the first sub-pixel is a B sub-pixel, the second sub-pixel is a R sub-pixel, the third sub-pixel is a G sub-pixel, or the first sub-pixel is a G sub-pixel, the second sub-pixel is a B sub-pixel, the third sub-pixel is a R sub-pixel, or the first sub-pixel is a G sub-pixel, the second sub-pixel is a R sub-pixel, the third sub-pixel is a B sub-pixel, or the first sub-pixel is a R sub-pixel, the second sub-pixel is a G sub-pixel, the third sub-pixel is a B sub-pixel, or the first sub-pixel is a B sub-pixel, the second sub-pixel is a G sub-pixel, the third sub-pixel is a R sub-pixel.

17. The display panel according to claim 11, wherein the G sub-pixel in each pixel unit is a quadrangle, and is arranged towards the same direction on the display panel.

18. The display panel according to claim 11, wherein the G sub-pixel in each pixel unit is a quadrangle, and the G sub-pixel on the display panel is arranged alternately towards a different direction.

19. The display panel according to claim 18, wherein the adjacent G sub-pixels are arranged in mirror symmetry.

20. A display device comprising a display panel according to claim 1.
